(19) United States
(12) Patent Application Publication
(10) Pub. No.: US 2009/0307758 A1
(43) Pub. Date: Dec. 10, 2009

(54) Method and apparatus to facilitate using a multicast stream to provide on-demand streaming content

(75) Inventors: Brett L. Lindsley, Wheaton, IL (US); Matthew J. Defano, Chicago, IL (US); JianJun Fang, Long Grove, IL (US); Alfonso Martinez Smith, Algonquin, IL (US); Robert G. Scheffler, Peyton, CO (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 12/133,897

(22) Filed: Jun. 5, 2008

(51) Int. Cl. G06F 15/16; G06F 21/00

(52) U.S. Cl. 726/4; 709/231

(57) ABSTRACT

A streaming content-on-demand service provider (400), upon receiving (301) from a remotely located content consumer (100) an on-demand request (406) for present delivery of a particular identified item of streaming content, allocates (303) a multicast address/port to which a multicast stream (411) comprising the streaming content will be provided. The content consumer (via, for example, a corresponding client platform) can then use this multicast address/port to receive the particular identified item of streaming content. Such an approach will serve to permit the initiation of a new stream of content to serve an initial request for such content. This approach will also permit, if desired, late joiners to begin receiving, mid-stream, content that has already begun streaming in response to an earlier client request for such content.

### TECHNICAL FIELD

This invention relates generally to the provision of streaming content and more particularly to the provision of on-demand streaming content.

### BACKGROUND

Streaming content of various kinds is known in the art. Generally speaking, streaming content comprises content (such as audio-only content, video-only content, and audio-visual content) that is renderable (and usually is rendered) more or less as it is received (allowing in some cases for the temporary buffering of some sufficient amount of content to permit such rendering to occur substantially without interruption prior to the initiation of such rendering). Streaming content contrasts in particular with a file transfer-based transfer of content which typically requires that a file that comprises the entire body of the content in question be first conveyed prior to initiating the playback of such content.

Streaming content comprises a useful way to provide content-on-demand services to a requesting client. Such an approach is used, for example, to provide video-on-demand services to requesting subscribers of network-based video services. In many cases, such services are facilitated by a server that utilizes User Datagram Protocol (UDP) to convey the corresponding media packets to the target client (as Transfer Control Protocol/Internet Protocol can be viewed as being too costly in terms of connection set-up, error correction, and so forth). This approach works relatively well when the network is controlled, end to end, by the service provider.

Unfortunately, such end-to-end control does not always characterize the application setting. In an increasing number of instances, as when the service provider effects its services via a public network such as the Internet, various network elements beyond the control of the service provider can stymie the delivery of such services. As but one example in this regard, a given client may only have access to the service provider through a firewall that has been set to block incoming UDP streams. Avoiding the protection of the firewall (by employing, for example, a pinhole through the firewall) to facilitate the delivery of such content is often an unacceptable practice.

### BRIEF DESCRIPTION OF THE DRAWINGS

The above needs are at least partially met through provision of the method and apparatus to facilitate using a multicast stream to provide on-demand streaming content described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises a flow diagram as configured in accordance with various embodiments of the invention; and

FIG. 4 comprises a block diagram/call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a streaming content-on-demand service provider, upon receiving from a remotely located content consumer an on-demand request for present delivery of a particular identified item of streaming content, allocates a multicast address/port to which a multicast stream comprising the streaming content will be provided. The content consumer (via, for example, a corresponding client platform) can then use this multicast address/port to receive the particular identified item of streaming content.

Such an approach will serve to permit the initiation of a new stream of content to serve an initial request for such content. This approach will also permit, if desired, late joiners to begin receiving, mid-stream, content that has already begun streaming in response to an earlier client request for such content.

So configured, streaming content can be delivered, on demand, to a given client platform in a manner that is compatible and consistent with the requirements of an intervening firewall. By one approach, for example, the client platform can facilitate the control of its own reception of the requested on-demand stream of content by using Internet Group Management Protocol (IGMP) Join and Leave commands that are firewall friendly and which avoid the use of UDP.

Those skilled in the art will recognize and appreciate that these teachings are readily implemented with only relatively modest changes in most cases to the operating practices of the implementing platforms. It will further be understood that these teachings are highly flexible and permit existing technologies to readily support various presently unrealized capabilities and functionality. It will also be appreciated that these teachings are highly scalable and will readily accommodate a wide variety of streaming content, a large number of streaming content sources and clients, and various supplemental acts and functionality.

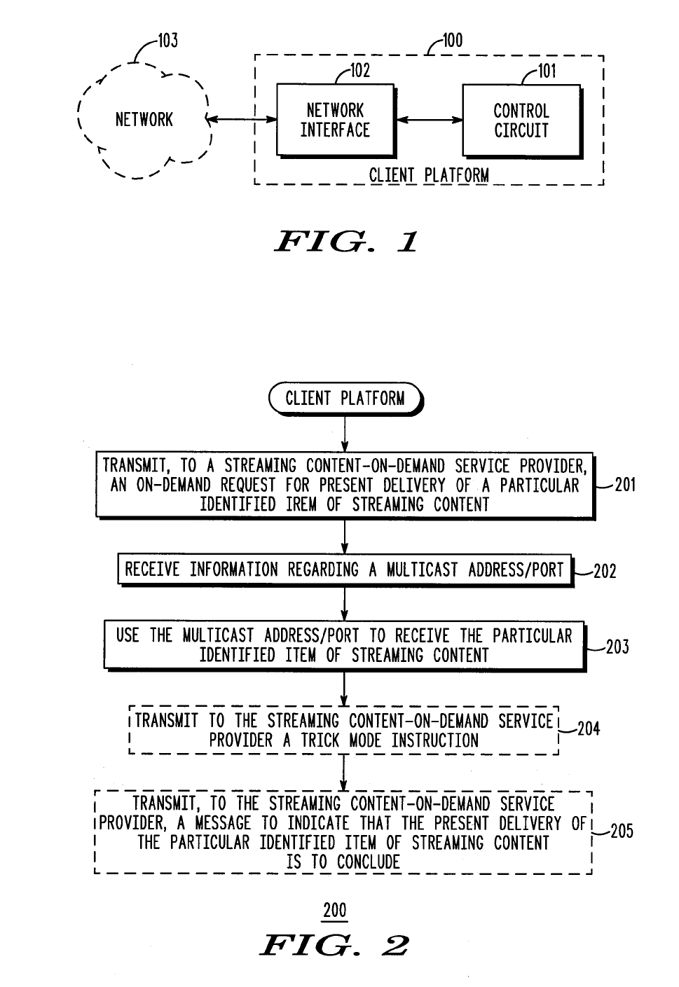

These and other benefits may become clearer upon making a thorough review and study of the following detailed description. Referring now to the drawings, and in particular to FIG. 1, it may be helpful to first describe and generally characterize an exemplary client platform 100 that can be configured in accordance with these teachings. This client platform 100 can assume any of a wide variety of form factors such as, but not limited to, a stand-alone so-called set-top box or other stand-alone platform. It would also be possible for this client platform 100 to be integrated with another platform of choice such as, but not limited to, a video game console, a television broadcast receiver, a desktop or personal/portable computer, a so-called media server, and so forth. Those skilled in the art will recognize and understand that these examples are intended to serve an illustrative purpose and are not intended as being suggestive of any particular limits in these regards.

This client platform 100 can comprise a control circuit 101 and a network interface 102 that operably couples to the control circuit 101. This network interface 102 can serve to communicatively couple the control circuit 101 to one or more external networks 103 (such as, but not limited to, the Internet or some other Transfer Control Protocol/Internet Protocol (TCP/IP)-based network of choice). This network interface 102 can comprise a wireless and/or wired interface as desired. Such network interfaces are known in the art and require no further description here. So configured, the control circuit 101 can readily communicate with one or more streaming content-on-demand service providers as described herein via such network access.

Those skilled in the art will recognize and appreciate that the control circuit 101 can comprise a fixed-purpose hard-wired platform or can comprise a partially or wholly programmable platform. All of these architectural options are well known and understood in the art and require no further description here. This control circuit 101 is configured (using, for example, corresponding programming as will be well understood by those skilled in the art) to carry out one or more steps, actions, and/or functions as are described herein.

Referring now to FIG. 2, this can comprise, as one example in these regards, carrying out a process 200 wherein the client platform 100 transmits 201, to a streaming content-on-demand service provider, an on-demand request for present delivery of a particular identified item of streaming content. This streaming content can vary with the requirements and/or opportunities as tend to characterize a given application setting. For example, this content can comprise audio only, video only, or audio-video content as desired. This request can comprise, for example a “play” command that is communicated, for example, using TCP/IP.

By one approach, this can comprise a request for the streaming content to begin streaming in the first instance. These teachings will also accommodate a late joining client platform. In such a case, a given end user may wish to join an in-progress stream of content. This may occur, for example, when a friend of the given end user has already initiated the streaming content and then contacted the given end user to request or suggest that they join in receiving the content. In this case, this request for streaming content can include information regarding that existing stream of content.

This request can also include such other information as may be necessary or useful with respect to facilitating the request and/or to facilitating the administration of the overall process or context. By one approach, for example, this information can include identifying information for the client platform and/or the given end user, billing information, authentication information, or the like. As another example, in lieu of the above or in combination therewith, this information can comprise data to identify the desired streaming content, streaming parameter requirements, encryption key information, special requests (such as limitations to apply or options to permit with respect to accommodating late joiners or the like), and so forth.

This process 200 then provides for receiving 202, from the streaming content-on-demand service provider (either directly or indirectly) information regarding a multicast address port. By one approach, this can comprise receiving this information in a Hypertext Transfer Protocol (HTTP) POST message (which message format is known in the art). Such a message is of course TCP/IP compatible and is readily conveyed by a TCP/IP compatible network (such as the Internet) and is also typically well accommodated by many firewalls. Those skilled in the art will recognize that multicast address ports are, in and of themselves, known in the art though not usually employed for these present purposes.

The client platform 100 then uses 203 this multicast address/port to receive the particular identified item of streaming content. This can comprise, for example, transmitting (via the aforementioned network 103) a request to that multicast address/port to join the supported content stream which corresponds to the requested demand for content. This request can comprise, for example, an Internet Group Management Protocol (IGMP) JOIN command though other approaches could be employed as desired.

By this approach, those skilled in the art will recognize and appreciate that such a process 200 permits and contemplates avoiding the use of UDP to instigate and/or receive content on demand. Instead, TCP/IP (in this particular illustrative example) serves to facilitate and support the described service.

If desired, and optionally, this process 200 will also accommodate trick mode instructions and functionality. As used herein, this reference to “trick” modes will be understood to include real-time manipulations of playback of the streaming content. Examples in this regard include, but are not limited to, pausing playback, fast forwarding playback, reversing playback, and so forth. By the illustrated approach, the client platform 100 transmits 204 a trick mode instruction as corresponds to the desired playback manipulation to the streaming content-on-demand service provider. As is also described below, the service provider can then implement the requested trick mode to thereby cause the stream of content to be modified in a corresponding manner. By this approach, then, the client platform 100 will then receive the streaming content as modified to facilitate the requested trick mode instruction.

This process 200 will also readily accommodate optionally transmitting 205 a message to the streaming content-on-demand service provider to indicate that the present delivery of the particular identified item of streaming content is to conclude. Such a message can be transmitted, for example, as an automatic action at the conclusion of the content stream. As another example, such a message can be transmitted in response to an indication from the given end user that the content stream be presently terminated. By one approach, and again by way of a non-limiting example, this can also include transmitting an IGMP LEAVE command to thereby conclude receiving the stream of content.

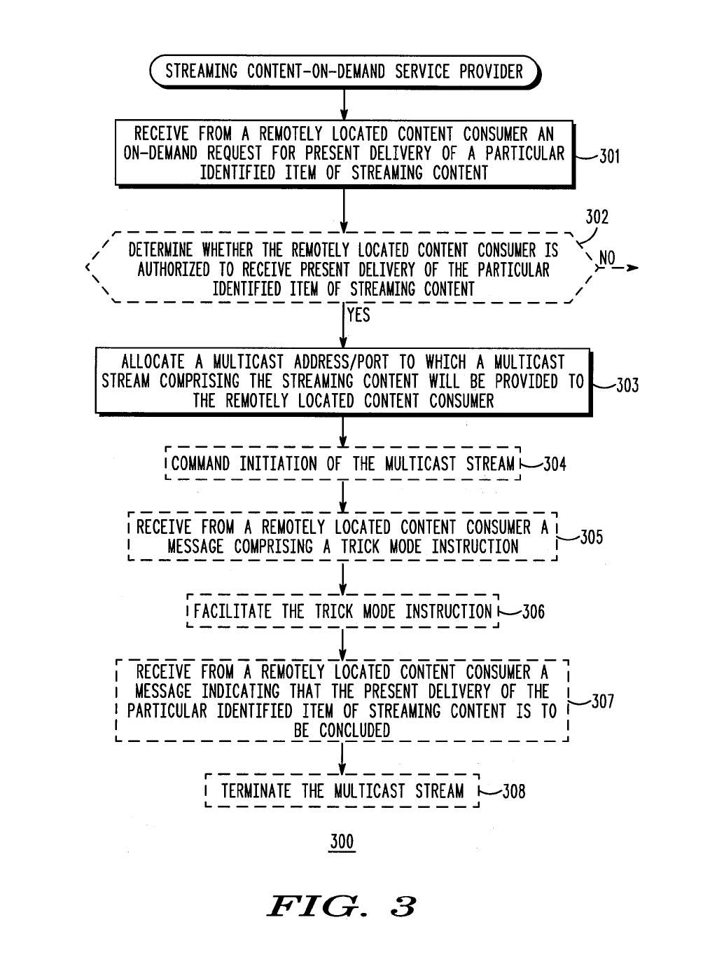

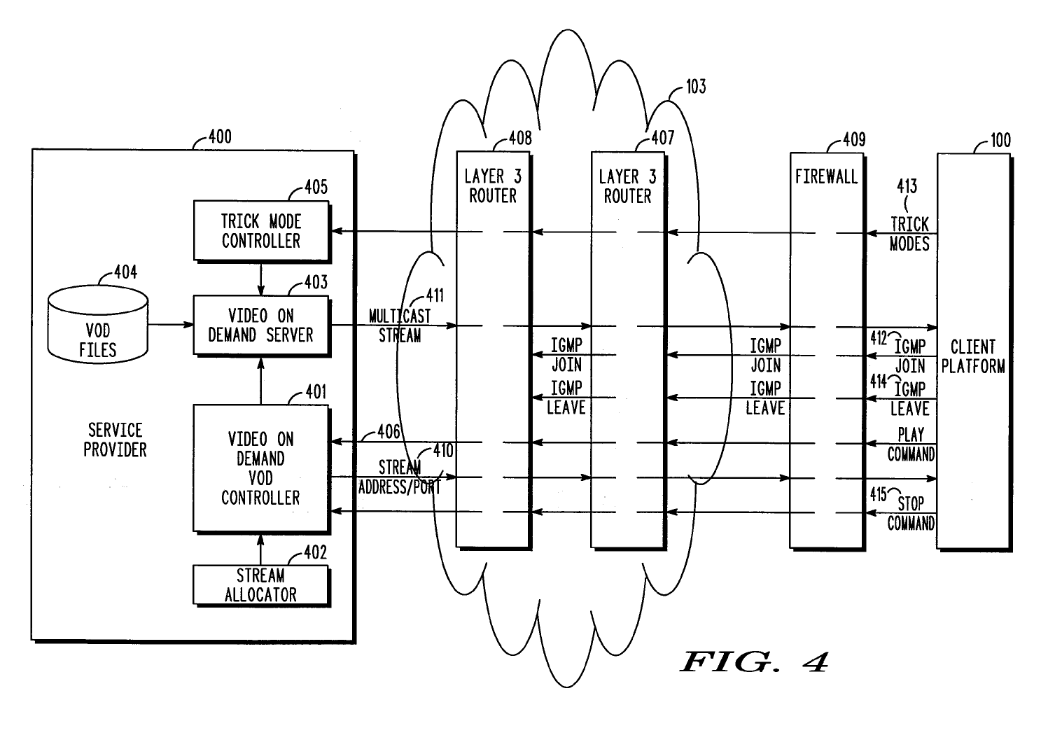

Referring now to FIGS. 3 and 4, this illustrative example will be continued to now include the aforementioned streaming content-on-demand service provider 400 and a corresponding process 300 that can be carried out by that service provider 400. In this illustrative example, the streaming content-on-demand service provider 400 comprises a streaming video content provider. Towards this end, the streaming content-on-demand service provider 400 comprises a video-on-demand (VOD) controller 401 that operably couples to a stream allocator 402 and a VOD server 403. The VOD server 403, in turn, operably couples to one or more stores of VOD files 404 (such as, but not limited to, MPEG4-encoded movies, television series episodes, and so forth) as well as a trick mode controller 405. Those skilled in the art will recognize that these components can comprise physically discrete components as suggested by the illustration or, if desired, one or more of these components can share a common enabling platform. Such architectural options are well known and understood in the art.

Pursuant to this process 300, the VOD controller receives 301 a message 406 from a content consumer (i.e., in this example, the aforementioned client platform 100), which message 406 comprises an on-demand request for present delivery of a particular identified item of streaming content. As noted above, this can comprise either an initial request as pertains to such content or might comprise a request by a late joining content consumer to begin receiving a content stream that was previously initiated.

As noted earlier, this message 406 makes its way from the client platform 100 to the streaming content-on-demand service provider 400 via at least one intervening network 103. In this example, this network 103 comprises the Internet. Accordingly, this message 406 traverses this network 103 via, in this example, at least a first and a second layer 3 router 407 and 408 as will be well understood in the art. In this illustrative example, the message 406 also passes through a firewall 409 that is disposed between the client platform 100 and the network 103.

By one optional approach, if desired, upon receiving this message 406 the VOD controller 401 can determine 302 whether the remotely located content consumer is authorized to receive present delivery of the particular identified item of streaming content. This can comprise, for example, determining whether the client platform 100 comprises an existing subscriber, or whether the client platform 100 is providing other credentials or consideration to support provision of the requested content. This authorization process may of course involve additional back-and-forth messages and may also involve having the VOD controller 401 access other resources such as a third party authentication or authorization server. Various authorization techniques are available and those skilled in the art will be well familiar with such options and opportunities.

When such a determination 302 reveals that the requesting entity or party is not so authorized, this process 300 can then take such additional follow-on actions as may be desired. By one simple approach, for example, the request can simply be ignored. By another approach, a message specifically denying the request can be forwarded to the requesting client platform 100.

When the client platform 100 is authorized, or when such authorization is not required, this process 300 then provides for allocating 303 a multicast address/port to which a multicast stream comprising the streaming content will be provided to the remotely located content consumer. As configured, the VOD controller 401 employs the stream allocator 402 to identify this multicast address/port in accordance with well recognized prior art practice in this regard. In this example, this multicast address/port corresponds to a particular one of the aforementioned layer 3 routers 408. This allocation step can further comprise transmitting a message 410 to the client platform 100 that contains information regarding this multicast address/port. Though this information can assume different forms as desired (for example, this message can be easily implemented using an HTTP POST that includes the stream information in the POST body), this information should be sufficient to permit the client platform 100 to access that particular multicast address/port.

This process 300 will also optionally permit the VOD controller 401 to command 304 the initiation of the requested multicast stream. This command can be directed to the VOD server 403. The VOD server 403, in turn, can begin streaming the requested content as retrieved from the VOD files 404. This multicast stream 411 is provided to the layer 3 router 408 which corresponds to the aforementioned multicast address/port.

As described above, the client platform 100 can then direct a JOIN message 412 using the multicast address/port to the corresponding layer 3 router 408. This router 408 then begins directing the aforementioned multicast stream 411 to the client platform 100.

This same basic approach can be used to permit a late joining content consumer to begin receiving this same multicast stream.

Also as noted earlier, the client platform 100 may be configured to permit the sourcing of trick mode instructions and/or requests 413. Accordingly, if desired, this process 300 can be optionally configured to permit the reception 305 of such a trick mode message 413 via, for example, the aforementioned trick mode controller 405. This trick mode controller 405 can then respond by facilitating 306 the received trick mode instruction. This can comprise, for example, instructing the VOD server 403 to take the corresponding action. To illustrate by way of example, when the trick mode message 413 includes a pause instruction, the trick mode controller 405 can instruct the VOD server 403 to pause the multicast stream. By one approach, for example, this can comprise continuing to provide a stream of content that comprises only the frame of the content at which point the pause became effective.

Again as noted above, the client platform 100 may be configured to source a LEAVE message 414 to cause the corresponding layer 3 router 408 to terminate further streaming of the multicast stream 411 to the client platform 100. This overall process 300 can also provide, at this time, for the client platform 100 to also source a message 415 to instruct the VOD controller 401 to stop the stream. Upon receiving 307 such a message 415, the VOD controller 401 take the appropriate corresponding actions to terminate 308 the multicast stream. This can comprise, for example, instructing the VOD server 403 to discontinue the identified multicast stream 411.

Those skilled in the art will recognize and appreciate that these teachings not only provide a highly flexible and effective way of delivering on-demand streaming content to an individual client platform, these steps are very friendly with respect to the operational sensitivities of the aforementioned firewall 409. As but one example in this regard, when employing NAT port translation (which these teachings will readily accommodate), the information returned to the client platform 100 from the service provider 400 (via, for example, a POST message) can be returned along the same path as the original outgoing request. This, in turn, will typically be readily permitted by the firewall 409 as it was the client platform 100 that initiated the original request and which created the context for the reply. Thus, many of the pitfalls as often befall prior art efforts in this regard are avoided.

Those skilled in the art will also recognize and appreciate that these teachings are readily employed using existing enabling platforms in conjunction, in some cases, with only some modest re-programming. This leveragability, coupled with the ready scalability of these teachings with respect to the number of service providers, client platforms, and individual multicast streams, constitutes an important benefit in these regards.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a streaming content-on-demand service provider:
receiving from a remotely located content consumer an on-demand request for present delivery of a particular identified item of streaming content;
in response to the on-demand request, allocating a multicast address/port to which a multicast stream comprising the streaming content will be provided to the remotely located content consumer.

2. The method of claim 1 further comprising:
commanding initiation of the multicast stream.

3. The method of claim 1 further comprising:
determining whether the remotely located content consumer is authorized to receive present delivery of the particular identified item of streaming content;
and wherein allocating a multicast address/port to which a multicast stream comprising the streaming content will be provided to the remotely located content consumer further comprises only allocating the multicast address/port when the remotely located content consumer is authorized to receive the present delivery of the particular identified item of streaming content.

4. The method of claim 1 wherein the on-demand request comprises an on-demand request for present delivery of a particular identified item of streaming content that is presently being streamed to another remotely located content consumer in response to an earlier on-demand request of the another remotely located content consumer.

5. The method of claim 1 further comprising:
receiving from a remotely located content consumer a message indicating that the present delivery of the particular identified item of streaming content is to be concluded;
in response to receiving the message indicating that the present delivery of the particular identified item of streaming content is to be concluded, terminating the multicast stream.

6. A method comprising:
at a client platform:
transmitting, to a streaming content-on-demand service provider, an on-demand request for present delivery of a particular identified item of streaming content;
receiving, from the streaming content-on-demand service provider, information regarding a multicast address/port;
using the multicast address/port to receive the particular identified item of streaming content.

7. The method of claim 6 wherein using the multicast address/port to receive the particular identified item of streaming content comprises transmitting to the multicast address/port using an Internet Group Management Protocol (IGMP) Join command.

8. The method of claim 6 wherein receiving information regarding a multicast address/port comprises receiving the information in a Hypertext Transfer Protocol (HTTP) POST message.

9. The method of 6 further comprising:
transmitting an Internet Group Management Protocol (IGMP) Leave command to conclude receiving the particular identified item of streaming content.

10. The method of claim 6 wherein transmitting an on-demand request for present delivery of a particular identified item of streaming content comprises transmitting an on-demand request to join a present delivery of a particular identified item of streaming content that is already being streamed to another client platform.

11. The method of claim 6 further comprising:
transmitting, to the streaming content-on-demand service provider, a message to indicate that the present delivery of the particular identified item of streaming content is to conclude.

12. The method of claim 6 further comprising:
transmitting to the streaming content-on-demand service provider a trick mode instruction.

13. The method of claim 12 wherein using the multicast address/port to receive the particular identified item of streaming content further comprises using the multicast address/port to receive the particular identified item of streaming content as modified to incorporate the trick mode instruction.

14. A client platform comprising:
a network interface;
a control circuit operably coupled to the network interface and being configured and arranged to:
transmit, to a streaming content-on-demand service provider via the network interface, an on-demand request for present delivery of a particular identified item of streaming content;
receive, from the streaming content-on-demand service provider and via the network interface, information regarding a multicast address/port;
use the multicast address/port to receive the particular identified item of streaming content via the network interface.

15. The client platform of claim 14 wherein the control circuit is further configured and arranged to use the multicast address/port to receive the particular identified item of streaming content by transmitting to multicast address/port using an Internet Group Management Protocol (IGMP) Join command.

16. The client platform of 14 wherein the control circuit is further configured and arranged to transmit an Internet Group Management Protocol (IGMP) Leave command to conclude receiving the particular identified item of streaming content.

17. The client platform of claim 14 wherein the control circuit is further configured and arranged to transmit to the streaming content-on-demand service provider a trick mode instruction.
